(19) United States
(12) Patent Application Publication
(10) Pub. No.: US 2016/0329662 A1
(43) Pub. Date: Nov. 10, 2016

(54) ELECTRICAL CONNECTOR AND ELECTRICAL CONNECTOR ASSEMBLY THEREOF

(71) Applicant: FOXCONN INTERCONNECT TECHNOLOGY LIMITED, Grand Cayman (KY)

(72) Inventors: CHAO-CHIEH CHEN, New Taipei (TW); CHIH-PI CHENG, New Taipei (TW)

(21) Appl. No.: 15/149,200

(22) Filed: May 9, 2016

(30) Foreign Application Priority Data
May 9, 2015 (CN) 201510231789.6

(51) Int. Cl. H01R 13/6595; H01R 43/24; H01R 13/659

(52) U.S. Cl. CPC H01R 13/6595; H01R 13/659; H01R 43/24

(57) ABSTRACT

An electrical connector assembly includes an insulative housing, at least a first terminal, at least a second terminal, a first metallic shell and a second metallic shell. The insulative housing has a base portion, a first tongue portion and a second tongue portion. The first and second tongue portions being disposed separately at a certain distance and parallel to each other. The first terminal has a first contacting portion and a first connecting leg. The second terminal has a second contacting portion and a second connecting leg. The first metallic shell surrounds the first tongue portion to form a first mating cavity. The second metallic shell surrounds at least a part of the second tongue portion to form a second mating cavity. The first and the second mating cavity are independent and closely stacked along a vertical direction.

### BACKGROUND OF THE INVENTION

1. Field of the Invention

The present invention generally relates to an electrical connector and an electrical connector assembly thereof, the electrical connector assembly has two stacked mating cavities.

2. Description of Related Art

USB association published a new connector in Aug. 11, 2014. The connector comprises a pug connector and a receptacle connector mating with each other. The plug connector can insert into the receptacle connector along two opposite directions. The receptacle connector which can transmit USB 2.0 signal and USB 3.1 signal is called USB Type C connector. Nowadays, the USB Type C connector is gradually familiar with consumers. Many connector manufactories take part in the developing activities on the new connector along with the system companies. However, the strong demands of the USB 2.0 A type connectors will always last a long time in the future in respect to the present situation. It means that a long time needed as the USB Type C connectors entirely replace the USB 2.0 connectors. At the same time, the electronic devices are becoming smaller and smaller, and the connector is configured as a low profile type is also a tendency.

Therefore, an electrical connector and an electrical connector assembly thereof configured as stacked type is provided to meet the demands described aforementioned would be desirable.

### SUMMARY OF THE INVENTION

Accordingly, an object of the present invention is to provide an electrical connector and an electrical connector assembly.

In order to achieve the object set forth, an electrical connector assembly comprising an insulative housing, at least a first terminal, at least a second terminal, a first metallic shell and a second metallic shell. The insulative housing has a base portion, a first tongue portion and a second tongue portion. The first tongue portion and the second tongue portion being disposed separately at a certain distance and parallel to each other. The first terminal has a first contacting portion arranged in the first tongue portion and a first connecting leg extending out of the base portion. The second terminal has a second contacting portion arranged in the second tongue portion and a second connecting leg extending out of the base portion. The first metallic shell surrounds the first tongue portion to form a first mating cavity therebetween. The second metallic shell surrounds at least a part of the second tongue portion to form a second mating cavity. The first mating cavity and the second mating cavity are independent and closely stacked along a vertical direction both perpendicular to the first tongue portion and the second tongue portion.

Other objects, advantages and novel features of the invention will become more apparent from the following detailed description when taken in conjunction with the accompanying drawings.

### BRIEF DESCRIPTION OF THE DRAWINGS

FIG. 1 is a perspective view of an electrical connector assembly of a first embodiment of the present invention;

FIG. 2 is a part exploded perspective view of the electrical connector assembly shown in FIG. 1;

FIG. 3 is a front perspective view of the electrical connector assembly shown in FIG. 1;

FIG. 4 is a perspective view of an electrical connector of a second embodiment of the present invention;

FIG. 5 is another perspective view of the electrical connector shown in FIG. 2, the second metallic shell is not shown;

FIG. 6 is a part exploded perspective view of the electrical connector shown in FIG. 5, the first metallic shell is not shown;

FIG. 7 is another perspective view of the electrical connector shown in FIG. 6.

FIG. 8 is an exploded perspective view of the first insulating housing shown in FIG. 6.

FIG. 9 is another perspective view of the first insulating housing shown in FIG. 8.

FIG. 10 is an exploded perspective view of the first insulating housing shown in FIG. 8.

FIG. 11 is another perspective view of the first insulating housing shown in FIG. 10.

FIG. 12 is a perspective view of the second terminals.

FIG. 13 is a perspective view of an independent electrical connector.

FIG. 14 is a perspective view of another embodiment wherein the first metallic shell is removed and replaced with a pair of confinement posts unitarily extending from the first base portion for restriction purpose.

FIG. 15 is a perspective view of another embodiment wherein the first metallic shell is removed and replaced with a pair of inwardly protrusions unitarily formed by the second metallic shell for restriction purpose.

### DETAILED DESCRIPTION OF THE INVENTION

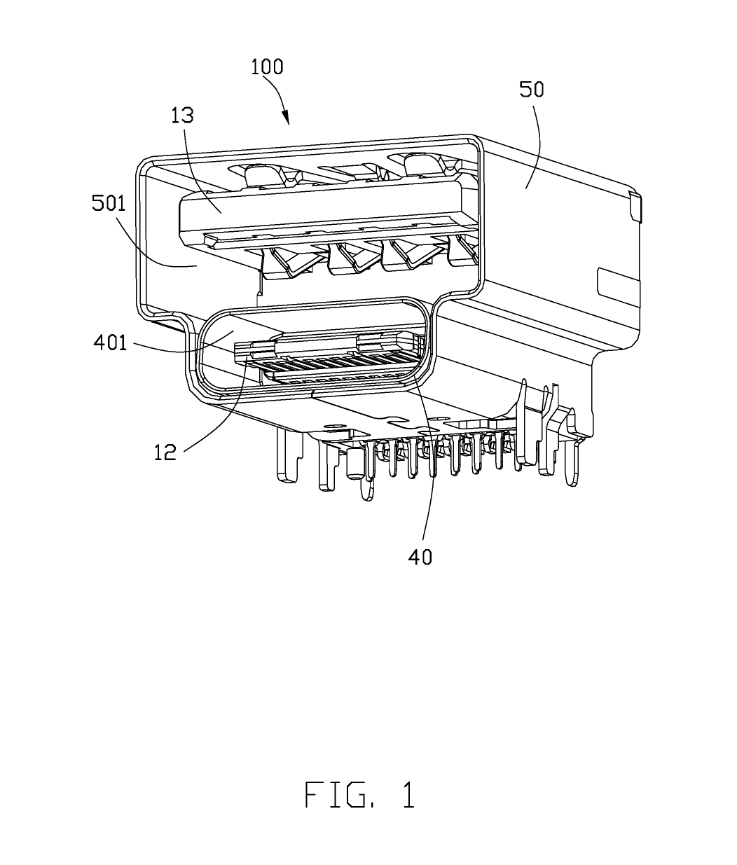

Reference will now be made in detail to the preferred embodiment of the present invention. Referring to FIG. 1 to FIG. 3, the present invention provided with an electrical connector assembly 100 comprising an insulative housing 10, at least a first terminal 20, at least a second terminal 30, a first metallic shell 40 and a second metallic shell 50. The insulative housing 10 has a base portion 11, a first tongue portion 12 and a second tongue portion 13. The first tongue portion 12 and the second tongue portion 13 are disposed separately and parallel to each other. The first metallic shell 40 surrounds the first tongue portion 12 to form a first mating cavity 401 therebetween. The second metallic shell 50 at least surrounds a part of the second tongue portion 13 to form a second mating cavity 501 therebetween. The first mating cavity 401 and the second mating cavity 501 are independent and closely stacked along a vertical direction perpendicular the first and second tongue portions 12, 13. The first mating cavity 401 is disposed under the second mating cavity 501. A transverse direction is perpendicular to the vertical direction. The sizes of the first mating cavity 401 along the transverse direction and the vertical direction are both smaller than those of the second mating cavity 501. The electrical connector assembly 100 can be applied in a variety of electronic devices like vehicle system. The electrical connector assembly 100 not only can mate with a USB 2.0 plug connector, but also can mate with a USB Type C plug connector. It is benefit for reducing the size of the electrical connector assembly 100 due to the closely stacking of the first mating cavity 401 and the second mating cavity 501.

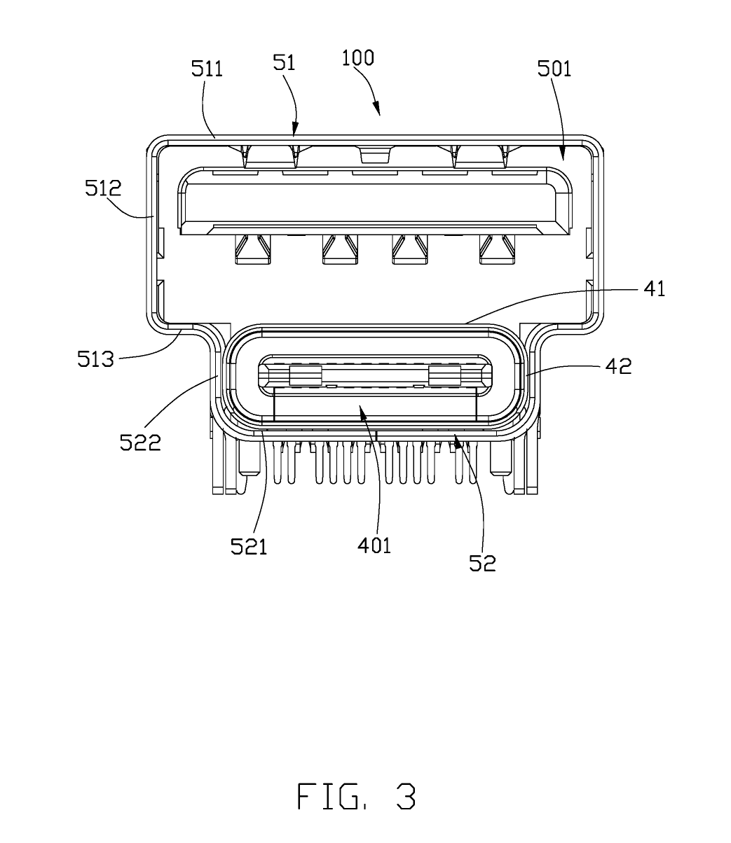

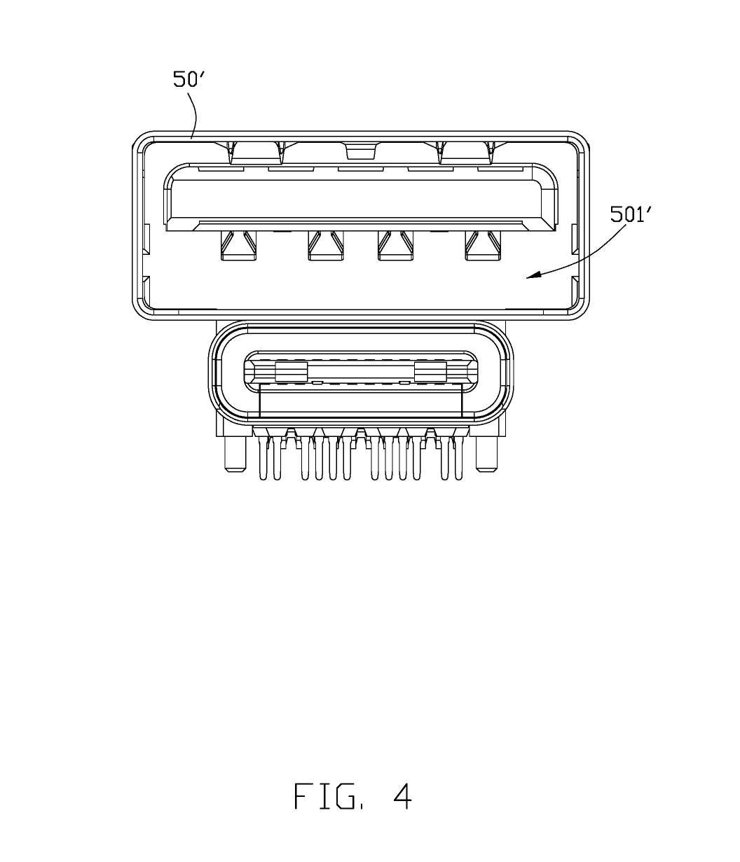

The first metallic shell 40 has a rectangular frame with four arc rounded corners. The first metallic shell 40 has two opposite long side walls 41 and two opposite short side walls 42. The second metallic shell 50 has a first section 51 surrounding the second tongue portion 13 and a second section 52 closely attached to an outer surface of the first metallic shell 40. The first section 51 and a long side wall 41 of the first metallic shell 40 together to form the second mating cavity 501 described aforementioned. The first section 51 has another long side wall 511, another two opposite short side walls 512 respectively bending from two sides of the another long side wall 511 and two connecting walls 513 respectively bending from the two short side walls 512. The two connecting walls 513 are both parallel to the long side wall 511. The second section 52 has another long side wall 521 and two another short side walls 522. The two connecting walls 513 respectively connect with the two corresponding short walls 522 of the second section 52. The second metallic shell 50 is formed by bending a metallic plate. It is clear to be seen from a front perspective view of the electrical connector 100 in FIG. 3 that the connecting walls 513 and the upper long side wall 41 of the first metallic shell 40 are together to form a lower long side wall of the second mating cavity 501. Of course, the second metallic shell 50 also can be configured as other different and comfortable structures. Such as the structure shown in FIG. 4, the second metallic shell 50′ independent and entirely surrounds the second tongue portion 13 to form said second mating cavity 501. In the specific embodiment, the first mating cavity 401 is fit for a USB Type C connector standard, the second mating cavity 501 is fit for a USB 2.0 Type A standard. The first mating cavity 401 and the second mating cavity 501 both have mating faces aligned with each other although a front side edge of the first metallic shell 40 is slightly inclined.

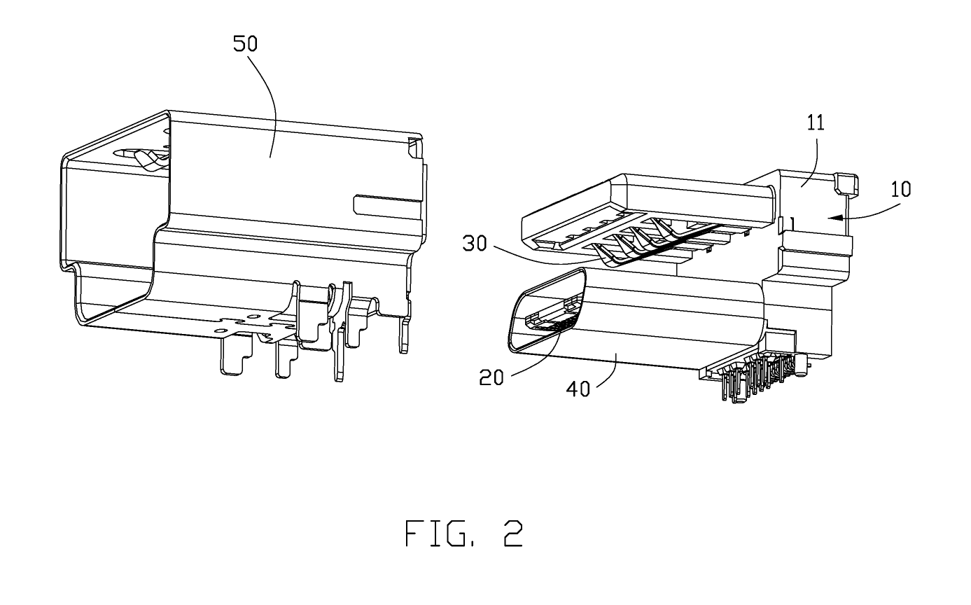

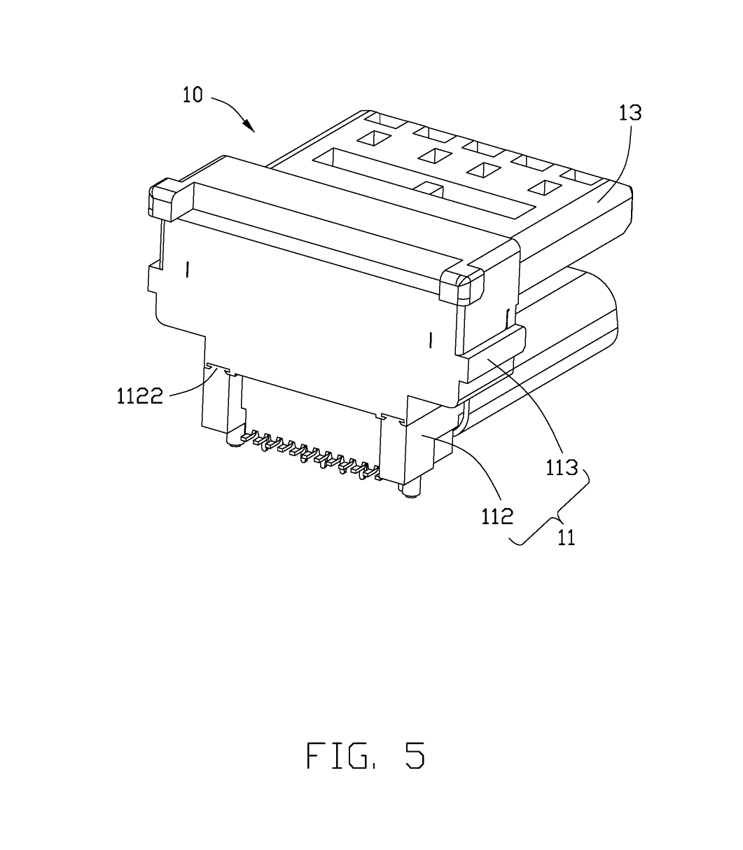

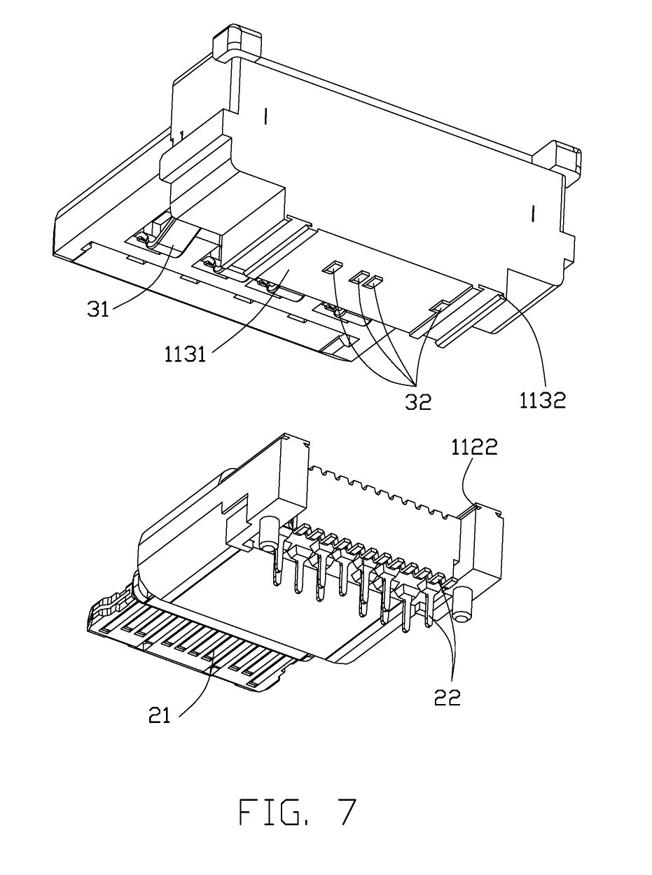

Mainly referring to FIG. 5 to FIG. 7, the specific structures of the electrical connectors 100 will be described here in the after. The base portion 11 of the insulative housing 10 has a first base portion 112 and a second base portion 113 assembled with each other. Said first tongue portion 12 extends forwardly from the first base portion 112, and the second tongue portion 13 extends forwardly from the second base portion 113. The first tongue portion 13 has a retaining portion 131 and a mating tongue 132 extending forwardly from the retaining portion 131. The mating tongue 132 has a stepping portion 133 disposed adjacent to the retaining portion 131 and having wider sizes than the other portion of the mating tongue 132 along both the transverse direction and the vertical direction. The first mating cavity 401 is located between the first metallic shell 40 and the mating tongue 132. Combined with FIG. 1 and FIG. 2, the first metallic shell 40 is retained to the retaining portion 131 to surround the first tongue portion 13. The second metallic shell 50 is retained to the first base portion 112 and the second base portion 113 to surround the first base portion 112 and the second base portion 113. Referring to FIG. 4, in other embodiment, the second metallic shell 50 can be only retained to the first base portion 112 and surrounds the first base portion 112. The first terminal 20 has a first contacting portion 21 arranged in the first tongue portion 12 and a first connecting leg 22 extending out of the first base portion 112. The second terminal 30 has a second contacting portion 31 arranged in the second tongue portion 13 and a second connecting leg 32 extending out of the second base portion 113. A plurality of said first terminals 20 and a plurality of the second terminals 30 are provided in the present embodiment. The first connecting legs 22 of the first terminals 20 have a row of through hole type legs extending downwardly and vertically and a row of SMT (surface mount type) legs extending horizontally. The second connecting legs 32 of the second terminals 30 bend initially and then extend horizontally. The second connecting legs 32 of the second terminals 30 are attached to a second face 1131 of the second base portion 113 which facing to the first base portion 112.

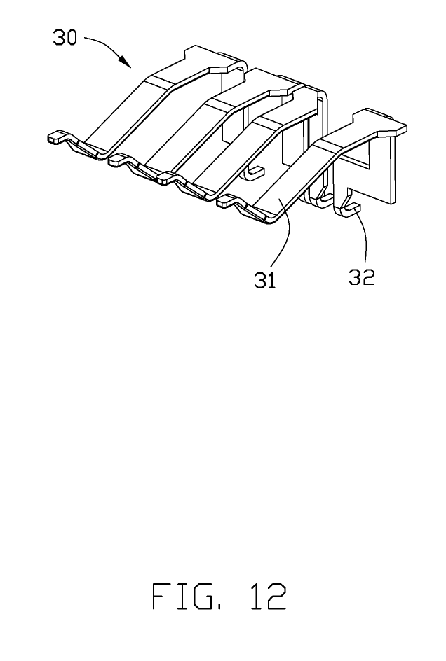

The first base portion 112 has a first face 1121 facing to the second base portion 113. The first face 1121 is lower than an upper surface of the retaining portion 131. The first terminal 20 has a first middle portion 23 connecting the first contacting portion 21 and the first connecting leg 22. A part of the first middle portion 23 of the first terminal 20 is exposed to the first face 1121 of the first base portion 112. After the first base portion 112 and the second base portion 113 are assembled with each other, each of the second connecting legs 32 of the second terminals 30 correspondingly contacts the first middle portion 23 of the first terminal 20. In the present invention, the second terminals 30 are functioned as USB 2.0 Type A terminals, the first terminals 20 are functioned as USB Type C terminals. Some terminals of the first terminals 20 are together to be functioned as USB 2.0 Type A terminals, thereby some terminals of the first terminals 20 and the second terminals 30 transmit the same signal. Referring to FIG. 12, the second contacting portions of the second terminals 30 are elastic structure, the second connecting legs 32 are offset relative to the second contacting portion 31 so as to be soldered to the corresponding first terminal 20 or press on the corresponding first terminals 20, thereby the first base portion 112 of the electrical connector assembly 100 of the present invention does not need to provide an extra portion extending through by the second connecting legs 32. Thus, it is benefit to reduce the size of the electrical connector assembly 100 along a front to back direction.

The first base portion 112 has at least a swallow-tail form rib 1122 at the first face 1121. The second base portion 113 has at least a swallow-tail form slot 1132 at the second face 1131 corresponding to the swallow-tail form rib 1122. In the present invention, two swallow-tail form ribs 1122 are respectively disposed at two sides of the first face 1121, and two swallow-tail form slots 1132 are respectively disposed at two sides of the second face 1131. After the first metallic shell 40 is assembled to the first tongue portion 12, the second base portion 113 is assembled to the first base portion 112 along with the swallow-tail form rib 1122 cooperating with the swallow-tail form slot 1132 so as to form a complete insulative housing 10. Referring to FIG. 5, the first base portion 112 and the second base portion 113 both have rear end surfaces aligned with each other so as to provide convenient for assembling the second metallic shell 50. The second metallic shell 50 has a rear wall entirely attached to the rear end surfaces of the first base portion 112 and the second base portion 113. Of course, the second metallic shell 501 is assembled to the insulative housing 10 after the first base portion 112 and the second base portion 113 assembled with each other.

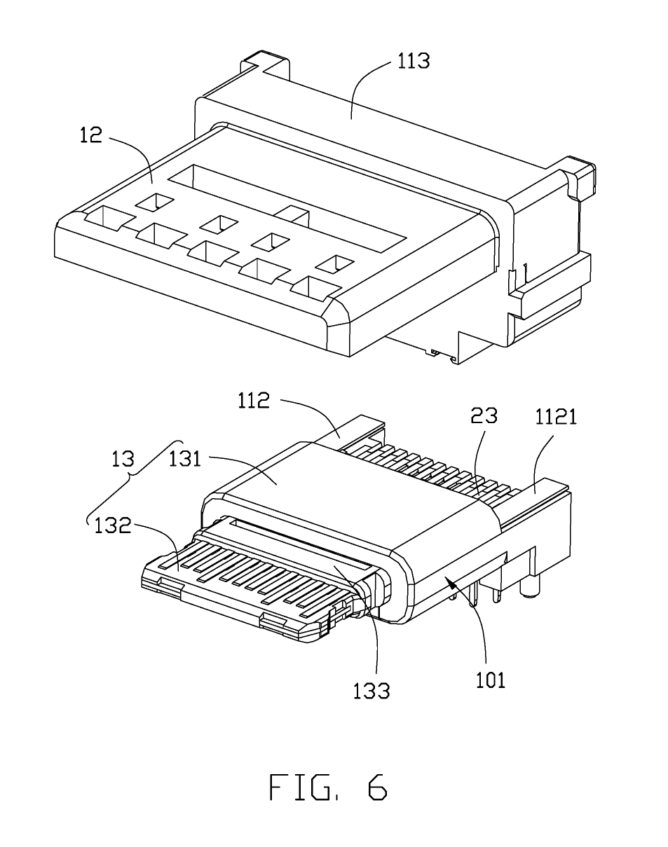

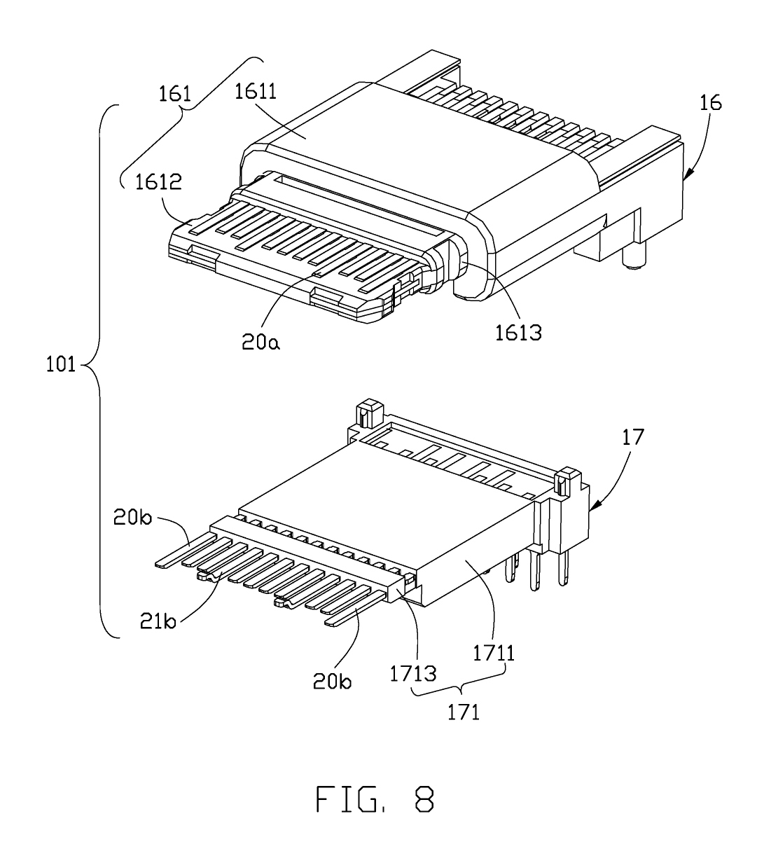

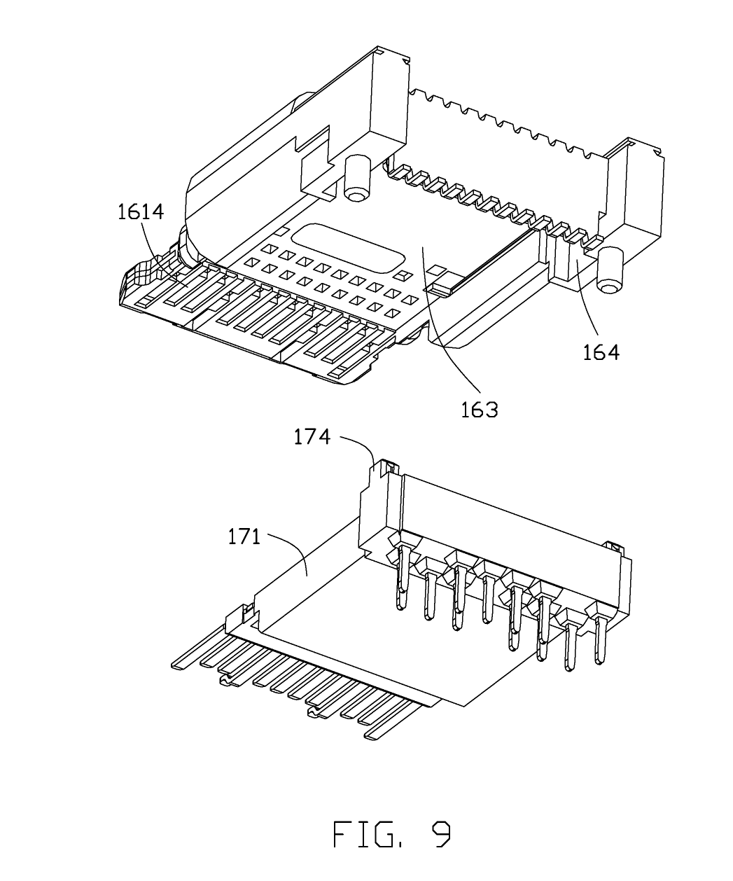

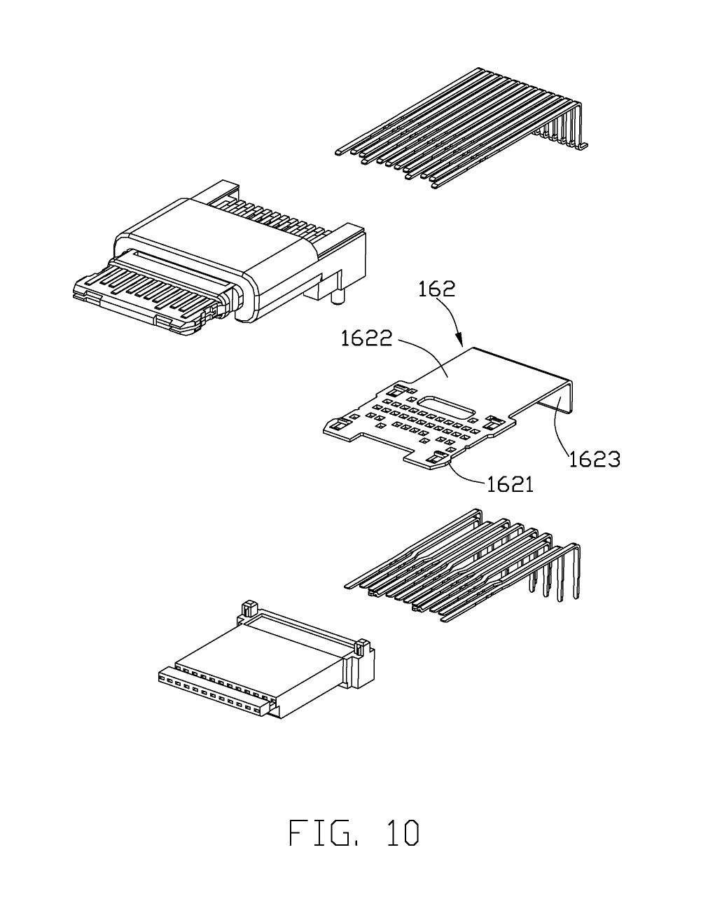

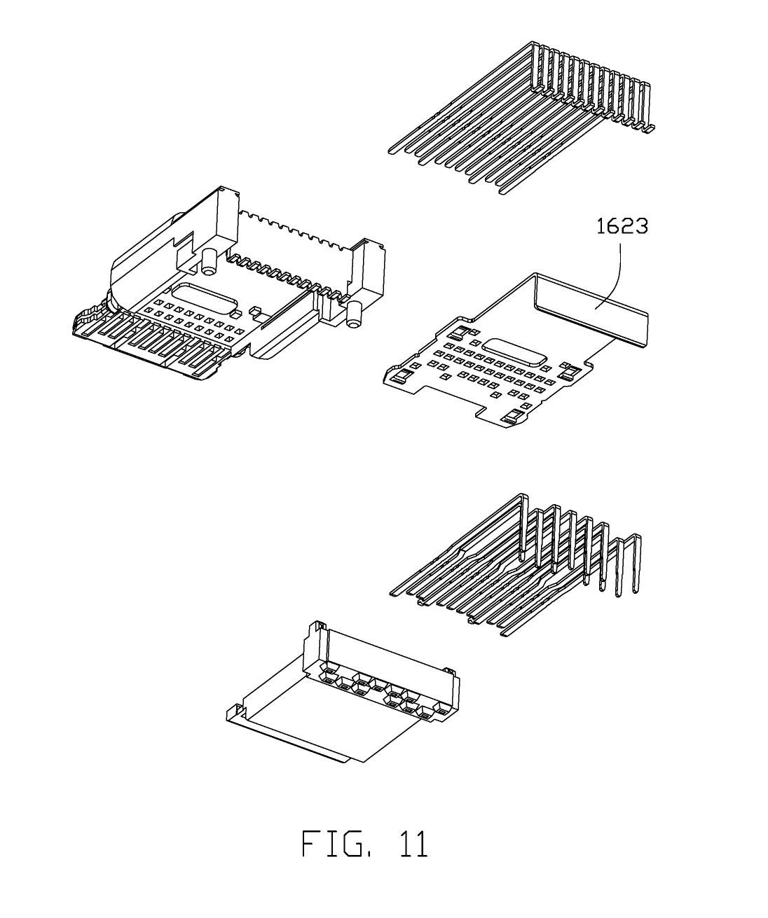

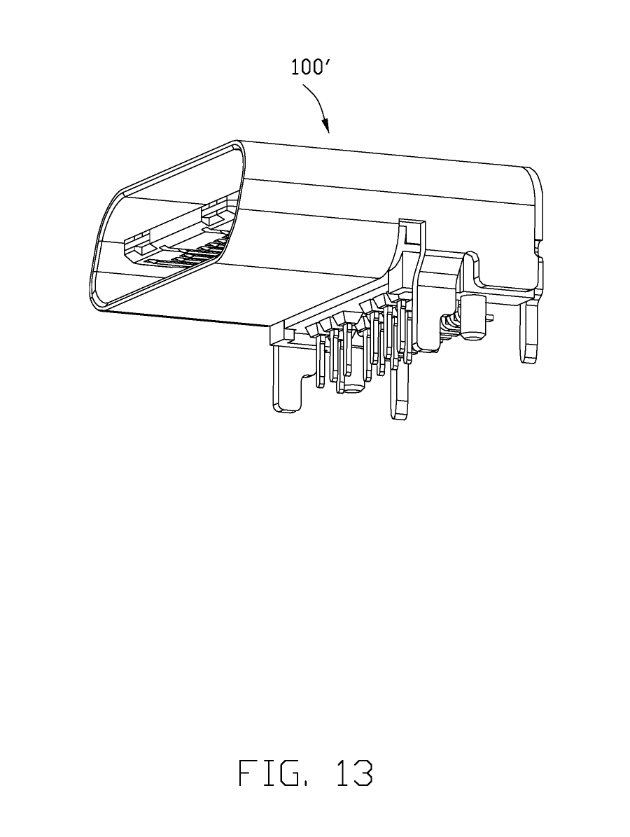

Referring to FIG. 8 to FIG. 11, combined with FIG. 6, the first metallic shell 40 surrounds the first tongue portion 12 to form a complete electrical connector. The electrical connector is disposed in the lower area of the electrical connector assembly 100. Certainly, in other embodiment, the electrical connector can be used independently. Such as the electrical connector 100′ shown in FIG. 13. The specific manufacturing process of the electrical connector will be described in detail here in the after. The electrical connector has a first insulating housing 101 with a plurality of first terminals 20 received therein and a first metallic shell 40. The first insulating housing 101 has a main portion and a mating tongue 132 extending forwardly. The first base portion 112 and the retaining portion 131 are together to form the main portion. The main portion is provided mainly to fix the first metallic shell 40 and form a mounting surface to be mounted to a circuit board. The first metallic shell 40 surrounds the first insulator 101 to form the first mating cavity 401 between the mating tongue 132 and the first metallic shell 40. The first mating cavity 401 is 180 configured as 180 degree symmetric relative to the mating tongue 132. The first insulating housing 101 has an upper terminal module 16 and a lower terminal module 17. The upper terminal module 16 has an upper insulator 161, a row of upper first terminals 20a embedded in the upper insulator 161 by insert molding technology and a shielding plate 162. The shielding plate 162 also can be embedded with the upper insulator 161 along with the upper first terminals 20a by insert molding technology. The lower terminal module 17 has a lower insulator 16 and a row of lower first terminals 20b embedded in the lower insulator 16 by insert molding technology. The upper terminal module 16 and the second terminal module 17 are assembled with each other to form a complete first insulating housing 101. The upper insulator 161 has an upper main portion 1611 and an upper mating tongue 1612. The upper mating tongue 1612 has an upper stepping portion 1613 with sizes wider than those of the other part of the upper mating tongue 1612 along the transverse direction and the vertical direction and being adjacent to upper main portion 1611. The row of upper first terminals 20a have upper first contacting portions arranged on an upper surface of the upper mating tongue 1612 and upper first connecting legs extending out of the upper main portion 1611. The upper mating tongue 1612 has a plurality of terminal grooves 1614 on a lower surface of the upper mating tongue 1612. The lower insulator 171 has a lower main portion 1711 and a lower stepping portion 1713. The row of lower first terminals 20b have lower first contacting portions 21b extending out of the lower stepping portion 1713 and lower first connecting portions extending out of the lower main portion 1711. After the upper terminal module 16 and the lower terminal module 17 are assembled with each other along a vertical direction, the lower first contacting portions 21b of the lower first terminals 20b are received in the terminal grooves 1614 on the lower surface of the upper mating tongue 1612. The upper stepping portion 1613 and the lower stepping portion 1713 are together to form the complete stepping portion 133. The upper main portion 1611 and the lower main portion 1711 are together to form the complete main portion. The upper mating tongue 1612 it self configured as the complete mating tongue 131. The upper main portion 1611 has a receiving room 163 recessed from the lower surface thereof. The lower main portion 171 is received in the receiving room 163. The upper main portion 161 has two guiding slots 164 running through the lower surface thereof and disposed at two sides of the receiving room 163. The lower main portion 171 has two guiding posts 174 inserting into the corresponding guiding slots 164. The shielding plate 162 has a main body 1622 embedded in the upper insulator 161 and a rear shielding portion 1623 extending out of the upper insulator 161. The rear shielding portion 1623 is located in front of the upper first connecting legs of the upper first terminals 20a. The shielding plate 162 has two latching portion 1621 disposed at two sides and protruding out of the mating tongue 132. The manufacturing process of the electrical connector is also fit for the independent electrical connector 100′.

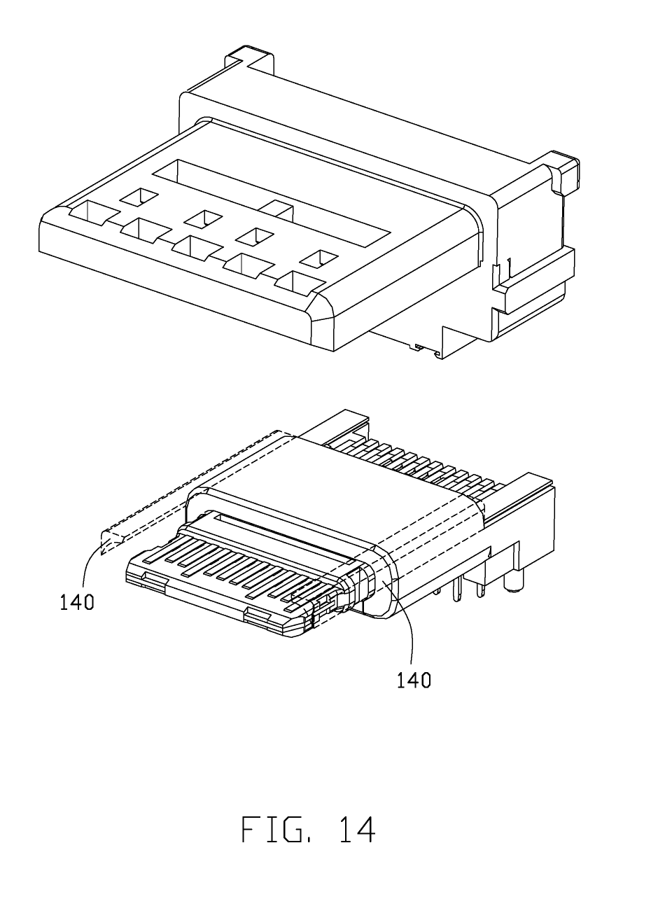

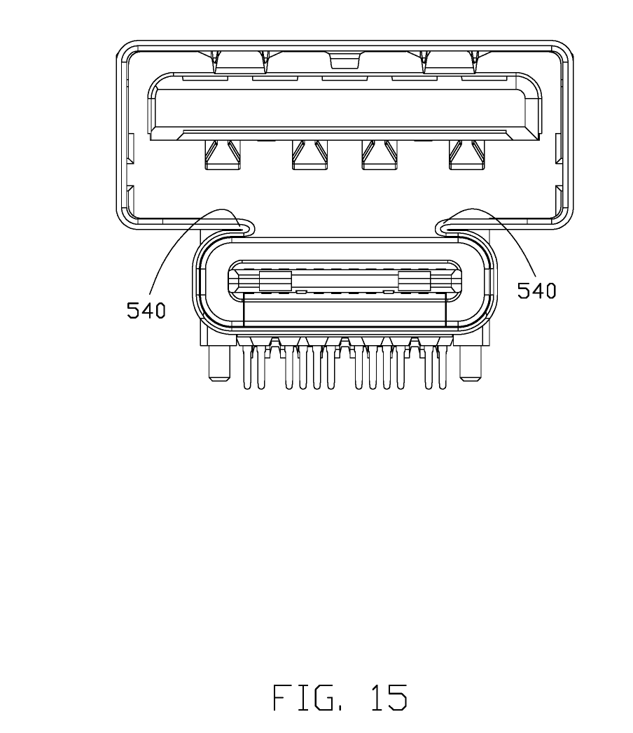

In another alternate embodiment, as shown in FIG. 14, the first metallic shell 40 may be omitted. Instead, a pair of confinement devices/posts 140 (shown in the dashed lines) around the interface boundary between the first mating cavity (around the first tongue portion 112) and the second mating cavity (around the second tongue portion 113) may integrally extend from the first base portion 112 so as to restrict the mated/complementary plug connector (USB type C) of the first mating cavity from upward moving into the second mating cavity. In another alternate embodiment, as shown in FIG. 15, such pair of confinement devices 540 may be replaced by inward protrusions integrally formed by or stamped from the second metallic shell 50. Understandably, the instant invention is to provide the double-deck arrangement of the dual connection units in a stacked manner wherein the first mating cavity for USB type C is smaller than the second mating cavity for USB type A in the transverse direction. Therefore, either using the pair of confinement posts unitarily forwardly extending from the first base section or a pair of inward protrusions unitarily formed by or stamped from the second metallic shell between the boundary between the first mating cavity and the second mating cavity, or using the independent metallic shell 40 within the common metallic shell 50 alternatively to efficiently divide these two mating cavities, is preferred for preventing improper relatively large forces from being imposed upon the first tongue portion 112 advantageously when the corresponding USB type C plug connector is received within the first mating cavity.

It is to be understood, however, that even though numerous characteristics and advantages of the present invention have been set forth in the foregoing description, together with details of the structure and function of the invention, the disclosure is illustrated only, and changes may be made in detail, especially in matters of shape, size, and arrangement of parts within the principles of the invention to the full extent indicated by the broad general meaning of the terms in which the appended claims are expressed.

We claim:

1. An electrical connector assembly comprising:
an insulative housing having a base portion, a first tongue portion and a second tongue portion, the first tongue portion and the second tongue portion being disposed separately at a certain distance and parallel to each other;
at least a first terminal having a first contacting portion arranged in the first tongue portion and a first connecting leg extending out of the base portion;
at least a second terminal having a second contacting portion arranged in the second tongue portion and a second connecting leg extending out of the base portion;
a first metallic shell; and
a second metallic shell;
wherein the first metallic shell surrounds the first tongue portion to form a first mating cavity therebetween, the second metallic shell generally surrounds the second tongue portion to form a second mating cavity, the first mating cavity and the second mating cavity are independent from each other for mating with different plug connectors, and closely stacked with each other along a vertical direction perpendicular to both the first tongue portion and the second tongue portion.

2. The electrical connector assembly as claimed in claim 1, wherein the second metallic shell has a first section surrounding the second tongue portion and a second section closely attached to an outer surface of the first metallic shell, the first section and a side wall of the first metallic shell together to form the second mating cavity.

3. The electrical connector assembly as claimed in claim 2, wherein the first section of the second metallic shell has a long side wall, two opposite short side walls respectively bending from two sides of the long side wall and two connecting walls respectively bending from the two corresponding short walls and being parallel to the long side wall; the second section of the second metallic shell has another long side wall and another two opposite short side walls respectively bending from the another corresponding two short side walls; the two connecting walls connect with the corresponding two short walls of the second section, the second metallic shell is formed by bending a metallic plate.

4. The electrical connector assembly as claimed in claim 2, wherein the second metallic shell independently and entirely surrounds the second tongue portion to form the second mating cavity; the second metallic shell is formed by bending a metallic plate.

5. The electrical connector assembly as claimed in claim 1, wherein the base portion of the insulative housing has a first base portion and a second base portion assembled with each other, the first tongue portion extends from the first base portion, the second tongue portion extends from the second base portion; the first metallic shell surrounds and is retained to a retaining portion of the first tongue portion which adjacent to the first base portion, the second metallic shell surrounds and is retained to the first base portion or both the first and second base portion.

6. The electrical connector assembly as claimed in claim 5, wherein the first tongue portion has the retaining portion and a mating tongue extending forwardly from the retaining portion, the mating tongue has a stepping portion having wider sizes than those of the other portion of the mating tongue along the vertical direction and a transverse direction perpendicular to the vertical direction, the first mating cavity is located between the first metallic shell and the mating tongue; the first mating cavity is fit for USB Type C standard, the second mating cavity is fit for USB 2.0 Type A standard; a mating face of the first mating cavity and a mating face of the second mating cavity are aligned with each other.

7. The electrical connector assembly as claimed in claim 1, wherein the base portion of the insulative housing has a first base portion and a second base portion, a first face of the first base portion and a second face of the second base portion are face to face with each other; the first terminal has a first middle portion connecting with the first contacting portion and the first connecting leg, a part of the first middle portion is exposed to the first face of the first base portion; the second connecting leg of the second terminal is horizontally attached to a second face of the second base portion and contacts with a corresponding first middle portion of the first terminal; a plurality of the first terminals are functioned as USB 2.0 Type A terminals, a plurality of second terminals are functioned as USB Type C terminals, some of the first terminals transmit a kind of signal same as that the second terminals transmit.

8. The electrical connector assembly as claimed in claim 1, wherein the base portion of the insulative housing has a first base portion and a second base portion assembled with each other, the first tongue portion extends forwardly from the first base portion, the second tongue portion extends forwardly from the second base portion.

9. The electrical connector assembly as claimed in claim 8, wherein viewed in a front-to-back direction, the second metallic shell either encloses the first metallic shell or is stacked with the first metallic shell in the vertical direction.

10. An electrical connector, comprising:
a first insulating housing having a main portion and a mating tongue extending forwardly from the main portion;
a plurality of first terminals received in the first insulating housing; and
a first metallic shell surrounding the first insulating housing to form a first mating cavity between the mating tongue and the first metallic shell, the first mating cavity being configured as 180 degree symmetric relative to the mating tongue;
wherein the first insulating housing has an upper terminal module and a lower terminal module, the upper terminal module has an upper insulator, a row of upper first terminals embedded in the upper insulator by insert molding technology and a shielding plate, the lower terminal module has a lower insulator and a row of lower first terminals embedded in the lower insulator by insert molding technology; the upper terminal module and the lower terminal module are assembled with each other to form the complete first insulating housing.

11. The electrical connector as claimed in claim 10, wherein the upper insulator has an upper main portion and an upper mating tongue, the upper mating tongue has an upper stepping portion having wider sizes than those of the other portion of the mating tongue along a vertical direction and a transverse direction perpendicular to the vertical direction, the upper first terminal has an upper contacting portion arranged at an upper surface of the upper mating tongue and an upper connecting leg extending out of the upper main portion; the lower insulator has a lower main portion and a lower stepping portion, the lower first terminal has a lower first contacting portion extending forwardly and out of the lower stepping portion and a lower first connecting leg extending out of the lower main portion; the upper mating tongue has a plurality of groove terminals recessed from a lower surface thereof; after the upper terminal module and the lower terminal module are assembled with each other, the lower first contacting portions of the lower first terminals are received in the terminal grooves of the upper mating tongue.

12. The electrical connector as claimed in claim 11, wherein the upper main portion has a receiving room recessed from the lower surface thereof, the lower main portion is received in the receiving room; the upper main portion has at least a guiding slot running through the lower surface of the upper main portion and disposed at a side of the receiving room, the lower main portion has at least a guiding post corresponding with the guiding slot.

13. The electrical connector as claimed in claim 12, wherein the upper main portion has two said guiding slot disposed at two sides of the receiving room and communicating with the receiving room, the lower main portion has two said guiding posts corresponding with the guiding slots.

14. The electrical connector as claimed in claim 11, wherein the shielding plate has a main body embedded in the upper insulator and a rear shielding portion extending out of the upper insulator, the rear shielding portion is located in front of the upper first connecting legs of the upper first terminals.

15. A double-deck connector assembly for use with a first plug connector unit and a second connector unit, comprising:
an insulative housing including, along a vertical direction, a first base section with a first mating tongue extending forwardly therefrom, a second base section with a second mating tongue extending forwardly therefrom, the first base section and the second base section being unified together;
a plurality of first terminals disposed in the first base section with first contacting sections exposed upon the first mating tongue;
a plurality of second terminals disposed in the second base section with second contacting sections exposed upon the second mating tongue;
a metallic shell enclosing both the first mating tongue and the second mating tongue either directly or indirectly; so as to form a first mating cavity around the first mating tongue for mating with the first connector unit and a second mating cavity around the second mating tongue for mating the second plug connector unit, both said first mating cavity and said second mating cavity forwardly communicating with an exterior in a front-to-back direction perpendicular to said vertical direction, the first mating cavity being smaller than the second mating cavity in the transverse direction perpendicular to both said vertical direction and said front-to-back direction; and
a pair of confinement devices located at two opposite ends of the first mating cavity around an interface boundary between the first mating cavity and the second mating cavity for restricting the first plug connector unit from moving toward the second mating cavity.

16. The double-deck connector assembly as claimed in claim 15, wherein said confinement devices are formed by either the first base section or the metallic shell.

17. The double-deck connector assembly as claimed in claim 15, further including another metallic shell enclosing the first mating cavity and enclosed in said metallic shell to function as the pair of confinement devices.

18. The double-deck connector assembly as claimed in claim 15, wherein said first base section and said second base section are discrete from each other and assembled with each other via a slot-rib structure along the front-to-back direction.

19. The double-deck connector assembly as claimed in claim 15, wherein the first mating cavity is related to a USB type C connector, and the second mating cavity is related to a USB type A connector.

20. The double-deck connector assembly as claimed in claim 15, wherein the first mating cavity is located below the second mating cavity, the first base section is equipped with a mounting posts while the second base section is not, and the first terminals includes both surface mounting and through hole types around corresponding tails while the second terminals only have the surface mounting type around corresponding tails.
